(19) United States
(12) Patent Application Publication
(10) Pub. No.: US 2017/0008018 A1
(43) Pub. Date: Jan. 12, 2017

(54) SPRAY GUN MOTION AND MOUNT

(71) Applicants: Kevin Michael Gillest, Arvada, CO (US); Michael W. Calahan, Arvada, CO (US); Byron Henze, Idaho Springs, CO (US)

(72) Inventors: Kevin Michael Gillest, Arvada, CO (US); Michael W. Calahan, Arvada, CO (US); Byron Henze, Idaho Springs, CO (US)

(21) Appl. No.: 15/099,689

(22) Filed: Apr. 15, 2016

Related U.S. Application Data
(63) Continuation-in-part of application No. 14/792,483, filed on Jul. 6, 2015.

(51) Int. Cl. B05B 13/06; B05D 1/02

(52) U.S. Cl. CPC B05B 13/0627; B05D 1/02

(57) ABSTRACT

A spray gun for spraying of interior surfaces of cylindrical items such as cans, containers, etc. may nod, changing angle in relationship to the can while spraying. This allows more efficient distribution of coating, reduce cost & coating material, and may reduce the number of spray guns and spray machines required. The spray gun may be used with a system having vertical spray or a rotating spray gun turret. The spray gun mount embodiment of the device may use a linear or curved electrical motor, and a linear electrical motor embodiment may be used for traditional lancing. In use, the device may spray a greater thickness of coating, in a liquid or semi-liquid phase, onto a first portion of the interior surface as compared to a second portion, allowing gravity to draw the coating into a different thickness profile.

### STATEMENT REGARDING FEDERALLY FUNDED RESEARCH

This invention was not made under contract with an agency of the US Government, nor by any agency of the US Government.

### CROSS-REFERENCE TO RELATED APPLICATIONS

This application claims the priority and benefit of previously filed U.S. patent application Ser. No. 14/792,483, filed 6 Jul. 2015. Both are copending and the entire disclosure of that application is incorporated herein by this reference.

### FIELD OF INVENTION

This invention relates generally to coating or spraying and specifically to the manufacture of cylindrical items such as cans/containers and the coating of the interior of such items.

### BACKGROUND OF THE INVENTION

Modern coating of the interiors of container relies upon spray gun technology. A typical spray gun has a barrel having a nozzle at the lower end and a feed mechanism at the upper end, often a spray nozzle body which is part of a recirculating loop of lacquer, paint and/or other coating. For purposes of this application the terms “cylindrical body” and “can” may be used interchangeably.

Traditionally, the cans descend in a track into a rotating star wheel, which is oriented vertically. As the star wheel rotates, the horizontal cans pass in front of the spray gun, which has been adjusted for the size and shape of cans being sprayed, and the spray gun is activated by automated controls for a brief period of time (some milliseconds) during which it coats the interior of the can. The process continues during a production operation or production run (or during a shift) and coats the interiors of many hundreds of cans per minute. Various means and methods might be employed to speed up the act of spraying the can during a production run, however, the present invention is not directed at that.

Normally, the spray gun is itself fixed in place. However, in known references, the spray gun may “lance”, that is move in a straight line into the interior of the cylindrical body. This motion in translation normally occurs only in the axis of the spray gun barrel and/or container.

Some spray machines use two spray guns in order to provide improved coating of the can interior. This is partially due to dwell time. (As noted previously, in a typical coating machine, a star wheel carries each can in a pocket until the can is beside the spray gun.) This rotation time while the can is transported may be as much as 20-50 milliseconds, during which time the spray gun sits idle. This is one of many reasons why known types of machines are limited to about 350 cpm (cans per minute) in an internal coating production spray system, equivalent to about 171 milliseconds per can. This is also one reason of several reasons why two guns are sometimes necessary to coat the entire interior surface of the cylindrical body, others reasons include the facts that some containers required additional coating for protection of product from the material of the container, steel containers may have different coating needs, there are “hard to hold” products and so on: the time beside the gun may be quite short, so one gun may not be able to coat the entire interior in the brief time in which the can sits still beside the gun. Note that in traditional machines, the time to “lance” into the can may consume time as well. Other motion of the gun while the can is stationary beside the gun would normally be considered unhelpful, as gun motion would in turn require additional time for spraying, further slowing production. Thus it is expected in the art that spray guns will remain motionless, or as motionless as possible, to speed production.

The present invention teaches the contrary innovation that a spray gun may move in rotation, not just in translation, nor yet while the gun remains still.

It would be beneficial to find ways in which a gun may rotate and move while being used to spray, thus offering more coverage of the interior of the can with a single gun.

It would further be preferable to provide a way to more evenly coat the interior of a cylindrical body.

### SUMMARY OF THE INVENTION

The present invention teaches the unexpected innovation that a spray gun may rotate while spraying a can, particularly (but not limited to) while the can is oriented vertically beneath the spray gun rather than horizontally beside it.

In one embodiment, the can and gun may rotate together as the can passes around the star wheel in its pocket, thus offering a longer time for the spraying with the rotating gun.

The invention may allow the application of a more even coating due to the gun motion, thus allowing the use of less coating material, one gun in place of two guns, thus saving material on coating costs. The invention may also allow the use of fewer spray machines per production line.

In embodiments, the invention may allow the application of more material in some locations (for example, for necking) than in other locations. The present invention teaches that the gun may stop the “nodding” rotation at angles/times during the cycle, or may nod at faster or slower speeds at different angles or parts of the cycle, or by other methods alter the amount of material deposited by the spray gun in a particular area.

In embodiments, the nod may be approximately 30 degrees, however, the invention is not so limited: larger and smaller angular nods may be possible.

In embodiments, the device may use a linear electric motor, a curved electric motor or goniometer as part of the spray gun mount. The device may use rails and rollers, or cams and cam followers.

In embodiments, the linear electric motor spray gun mount of the invention may be used for lancing, the translation motion into the cylindrical body.

These and many other aspects, advantages, embodiments and objectives of the present invention will be understood by reference to the following.

### SUMMARY IN REFERENCE TO THE CLAIMS

It is therefore one aspect, advantage, objective and embodiment of the present invention, in addition to those described above, to provide a sprayer for coating the inner surface of a cylindrical item of manufacture, the sprayer comprising:

a generally cylindrical spray gun barrel having a first back end to receive a coating such as lacquer and a second nozzle end to spray the coating, the spray gun barrel having a longitudinal axis;

the spray gun barrel and such cylindrical item of manufacture being held respectively by a gun mount and a vacuum chuck, the spray gun barrel and such cylindrical item of manufacture being held at a mutual angle theta, the spray gun barrel nozzle end and such cylindrical item of manufacture also being held in a first mutual position;

the gun mount being operative to rotate the spray gun barrel while the spray gun barrel is spraying such inner surface of such cylindrical item of manufacture, the center of the rotation C being the nozzle, the mutual angle theta changing from a first angle theta-sub-1 to a second angle theta-sub-2 due to the rotation;

whereby the mutual angle theta changes but the first mutual position of the spray gun nozzle and such cylindrical item of manufacture does not change.

It is therefore a second aspect, advantage, objective and embodiment of the present invention, in addition to those described above, to provide a sprayer wherein the gun mount further comprises:

a curved rail, the rail having a radius of curvature equal to the length L of the spray gun barrel as measured from the rail to the nozzle, the radius of curvature having a focus at the center of rotation C.

It is therefore another aspect, advantage, objective and embodiment of the present invention, in addition to those described above, to provide a sprayer wherein the gun mount further comprises:

a gun mounting plate, the gun barrel attached to the gun mounting plate, the gun mounting plate having guides movably affixed to the curved rail such that the guides, gun mounting plate and gun barrel may ride along the curved rail but may not depart from the curved rail.

It is therefore one aspect, advantage, objective and embodiment of the present invention, in addition to those described above, to provide a sprayer wherein the guides are rollers.

It is therefore one aspect, advantage, objective and embodiment of the present invention, in addition to those described above, to provide a sprayer wherein the guides are cam followers.

It is therefore one aspect, advantage, objective and embodiment of the present invention, in addition to those described above, to provide a sprayer comprising a linear actuator having a first end attached to the gun mounting plate and having a second end attached to a spray gun turret;

the spray gun turret revolving with the star wheel and holding the spray gun in the first mutual position as the star wheel and spray gun turret revolve;

the linear actuator operative to move the spray gun barrel while it is spraying, thereby causing the rotation of the spray gun.

It is therefore one aspect, advantage, objective and embodiment of the present invention, in addition to those described above, to provide a sprayer wherein the linear actuator is a linear electric motor.

It is therefore one aspect, advantage, objective and embodiment of the present invention, in addition to those described above, to provide a sprayer wherein the gun mounting plate further comprises:

a positioning goniometer, the positioning goniometer operative to move the spray gun barrel along the rail while it is spraying, thereby causing the rotation.

It is therefore one aspect, advantage, objective and embodiment of the present invention, in addition to those described above, to provide a sprayer wherein the linear actuator allows the spray gun to rotate to any angle within the range theta-sub-1 to theta-sub-2.

It is therefore one aspect, advantage, objective and embodiment of the present invention, in addition to those described above, to provide a sprayer wherein the range theta-sub-1 to theta-sub-2 is at least 30 degrees.

It is therefore yet a different and additional aspect, advantage, objective and embodiment of the present invention, in addition to those described above, to provide a sprayer for coating the inner surface of a cylindrical item of manufacture, the sprayer comprising:

a generally cylindrical spray gun barrel having a first back end to receive a coating such as lacquer and a second nozzle end to spray the coating, the spray gun barrel having a longitudinal axis;

the spray gun barrel and such cylindrical item of manufacture being held respectively by a gun mount and a star wheel, the spray gun barrel and such cylindrical item of manufacture being held at a mutual angle theta, the spray gun barrel nozzle end and such cylindrical item of manufacture also being held in a first mutual position;

a linear actuator attached to the gun mount, the linear actuator being operative to move the spray gun barrel in translation along the longitudinal axis toward such cylindrical item of manufacture while the spray gun barrel is spraying such inner surface of such cylindrical item of manufacture.

It is therefore one aspect, advantage, objective and embodiment of the present invention, in addition to those described above, to provide a method for coating the inner surface of a cylindrical item of manufacture, the method comprising:

providing a sprayer able to spray a greater amount of a coating at a first location compared to a second location, the coating being at least partially liquid phase;

spraying the greater amount of coating at the first location compared to the second location.

It is therefore one aspect, advantage, objective and embodiment of the present invention, in addition to those described above, to provide a method further comprising:

allowing gravity to draw coating material from the first location to the second location before the coating material starts to solidify.

It is therefore one aspect, advantage, objective and embodiment of the present invention, in addition to those described above, to provide a method wherein such cylindrical item of manufacture has an open end and a closed end; and further comprising the step of:

orienting vertically the cylindrical item of manufacture while it is being sprayed, with the open end upward;

and further wherein:

the first location is near to such open end and the second location is near to such closed end.

It is therefore one aspect, advantage, objective and embodiment of the present invention, in addition to those described above, to provide a method wherein the step of providing the sprayer further comprises providing a sprayer comprising:

a generally cylindrical spray gun barrel having a first back end to receive the coating and a second nozzle end to spray the coating, the spray gun barrel having a longitudinal axis;

the spray gun barrel and such cylindrical item of manufacture being held respectively by a gun mount and a star wheel, the spray gun barrel and such cylindrical item of manufacture being held at a mutual angle theta, the spray gun barrel nozzle end and such cylindrical item of manufacture also being held in a first mutual position, the spray gun turret revolving with the star wheel and holding the spray gun in the first mutual position as the star wheel and spray gun turret revolve;

the gun mount being operative to rotate the spray gun barrel while the spray gun barrel is spraying such inner surface of such cylindrical item of manufacture, the center of the rotation C being the nozzle, the mutual angle theta changing from a first angle theta-sub-1 to a second angle theta-sub-2 due to the rotation;

whereby the mutual angle theta changes but the first mutual position of the spray gun nozzle and such cylindrical item of manufacture does not change;

the gun mount having a curved rail, the rail having a radius of curvature equal to the length L of the spray gun barrel as measured from the rail to the nozzle, the radius of curvature having a focus at the center of rotation C, the gun mount further having a gun mounting plate, the gun barrel attached to the gun mounting plate, the gun mounting plate having guides movably affixed to the curved rail such that the guides, gun mounting plate and gun barrel may ride along the curved rail but may not depart from the curved rail. a linear actuator having a first end attached to the gun mounting plate and having a second end attached to a spray gun turret;

the linear actuator operative to move the spray gun barrel while it is spraying, thereby causing the rotation of the spray gun.

### BRIEF DESCRIPTION OF THE DRAWINGS

FIG. 1 is a cross-sectional simplified view of a nodding spray gun according to the first embodiment of the invention, showing some exemplary positions which it can attain while rotating and the effect on spraying within the cylindrical body, in this case a can.

FIG. 2 is a cross-sectional view of a spray machine showing the context of use of the second embodiment, with spray guns on a rotating turret above a rotating star wheel in a vertical spray orientation.

FIG. 3 is a cross-sectional view of a spray machine showing the context of use of the third embodiment, with spray guns on a rotating turret above a rotating star wheel in the traditional horizontal orientation.

FIG. 4 is a side view of a fourth embodiment of the invention showing a positioning goniometer spray gun mount as well as the spray gun in two exemplary positions, the angle of rotation, center of rotation and so on.

FIG. 5 is a side view of a fifth embodiment of the invention showing a linear actuator and curved linear rail spray gun mount as well as the spray gun and its mount in two exemplary positions, the angle of rotation, center of rotation and so on, plus a short section of the overall machine.

FIG. 6 is a PRIOR ART vastly simplified cross-sectional view of a cylindrical body immediately after being sprayed with a prior art spray gun.

FIG. 7 is a PRIOR ART vastly simplified cross-sectional view of a cylindrical body after being sprayed with a prior art spray gun and further after the coating has had time to sag downward on the interior surface of the cylindrical body.

FIG. 8 is a vastly simplified cross-sectional view of one potential differential thickness coating (“pattern”, though that term is less accurate) of a cylindrical body immediately after being sprayed with a nodding spray gun according to the invention.

FIG. 9 is a vastly simplified cross-sectional view of one a potential differential coating thickness of a cylindrical body after being sprayed with a nodding spray gun according to the invention and additionally, after the coating has had time to sag downward on the interior surface of the cylindrical body.

FIG. 10 is a partially transparent side view of a spray gun moving in a lancing motion, showing various exemplary positions.

### INDEX OF REFERENCE NUMERALS

Cylindrical body 100
Open end 102
Closed end (dome) 104
Spray gun 200
Gun mount 201
Gun mount turret 202
Star wheel 204
Can 206
Can spinner/vacuum chuck 208
Bottom support/bearing 210
Top support/bearing 212
Support/drive shaft 214
Spray gun 300
Gun mount 301
Gun mount turret 302
Star wheel 304
Can 306
Can spinner/vacuum chuck 308
Right support/bearing 310
Left support/bearing 312
Support/drive shaft 314
Spray gun 400
Center of rotation at nozzle 402
Rotation 404
Angular freedom of rotation 406
Positioning goniometer 408
Spray gun 500
Center of rotation at nozzle 502
Rotation angle 506
Gun mounting plate 508
Guides/followers 510
(Curved) Linear rail 512
Linear actuator 514
Gun assembly mounting plates 516
Can 600
Open end (to be necked) 602
Coating (partially fluid phase) 604
Can 600′
Coating (slumped/sagged) 604′
Can 800
Open end 802
Coating (differential thickness) 804
Can 800′
Coating (gravity drawn) 804′
Spray gun 1100
First exemplary position 1000a
Thirteenth exemplary position 1000m
First position spray area 10002a
Thirteenth position spray area 10002m
Start position example 4000a
End position example 4000z
First angular position 5000a
Second angular position 5000b
Start position example 10000a
End position example 10000m
Initial spray area 10002a
Lancing spray area 10002m

### DETAILED DESCRIPTION

### Glossary

As used herein a cylindrical body/cylindrical item of manufacture/can may refer to any object such as a package for a consumer good (food or beverage container, aerosol, paint, health and beauty, etc.), which has a generally cylindrical body with an open end (the open end may only be present briefly during manufacture before being closed) and which requires coating, lacquer or painting on the inside/interior surface. Examples include aluminum and steel cans (for beverages, food and other products) but may include any item, made of metal or polymer, which may be coated internally.

“Necking” may not be limited to strictly the operation of necking/diametric reduction of a partially made cylindrical body but to any metal forming operation which may require extra coating be applied to a part of the can interior.

As used herein, “differential coating thickness” may refer to applying a coating with a different thickness in one area of the interior compared to another area of the interior. This so-called pattern is most likely to mean additional thickness near and on the area of necking and similar operations but reduced thickness lower down the can interior, where the coating may sag or become thicker or simply may not require as much thickness.

As used herein a spray gun refers to an industrial spray device used for coating the interior of cylindrical bodies such as and including cans. The coatings may be lacquer, coating or the like.

A spray system on the other hand refers to an entire machine, which may traditionally have one or even two spray guns (but which in the present invention may have more). The machine will typically include not just the spray guns but also feed tubes which connect to the rear/back end of the spray guns, feed source, controls, a support/drive shaft, and a star wheel and can conveying rails or the like, etc.

A spray gun barrel is the pressure spray part of a spray machine which actually ejects paint, lacquer or coating in the form of a spray of very fine droplets. Generally, the spray gun barrel will have an overall cylindrical configuration with numerous indents, furls, additions and so on, particularly including a feed-body near the back end, the feed body being the port, chamber, block, or structure which accepts liquid spray material into the cylindrical body from a feed source. The feed source may be a recirculating loop containing the material or may be a one way feed line (recirculation being quite common in can coating processes). The spray gun barrel will have a nozzle and/or nozzle end, usually the end closest to the cylindrical item of manufacture, which reduces the liquid flowing inside the barrel to a fine spray of droplets of the liquid, for example, by “atomizing” (which term has little to do with actual atoms) the liquid.

The spray gun barrel, being generally cylindrical, will have a longitudinal axis. This longitudinal axis may be measured in several ways without detracting from the scope of the present invention or departing from the ordinary mathematical terminology for an axis of a cylinder. It may be measured to several different lengths, for example, the entire length of the spray gun barrel might be used, however, for purposes of the present invention the term the length of the gun barrel indicates, that a measurement may be made along the longitudinal axis but not necessarily including the entire length of the spray gun barrel, rather to the part connected to a gun mounting plate, positioning goniometer, or the like.

A positioning goniometer is a device used to provide exact measured arcuate (“arc based”) location, that is, a device which moves to a precise angle. In the present invention, this motion is along a track or rail.

An arc or a curved body carries the ordinary definition of a segment of the perimeter of a conic section, that is, a part of a circle or ellipse. Such an arc or curved body defines a focus: a center of a circle or a focus of an ellipse, parabola and so on.

A rail may be any device which allows travel along its length but prevents travel sideways, travel off of the rail and so on. A rail may be a cam, a track, or any similar body.

A plate may be any substantially flat body, or may refer to a thicker body such as a block.

Geometrical terms used herein have their normal mathematical meanings. While the structures of the invention can be claimed without reference thereto, the use of such geometrical terms provides clarity regarding the structures, for example, about the exact shape of arcuate slots, the nature of spray gun mounts and so on.

The generally interchangeable terms “rotate” and “revolve” have been largely split apart for this application. “Revolve” will refer to the angular motion of the star wheel and spray gun turrets about the shaft of the sprayer. However “rotate” will refer to the gun nod (“nodding”) of the spray guns, which will rotate about the nozzle end of the guns subtending a small angle and then retreating rather than continuing to go around and around, as the star wheel and turret do. This definition is made in no way to be limiting, but merely to be clarifying.

### GLOSSARY END

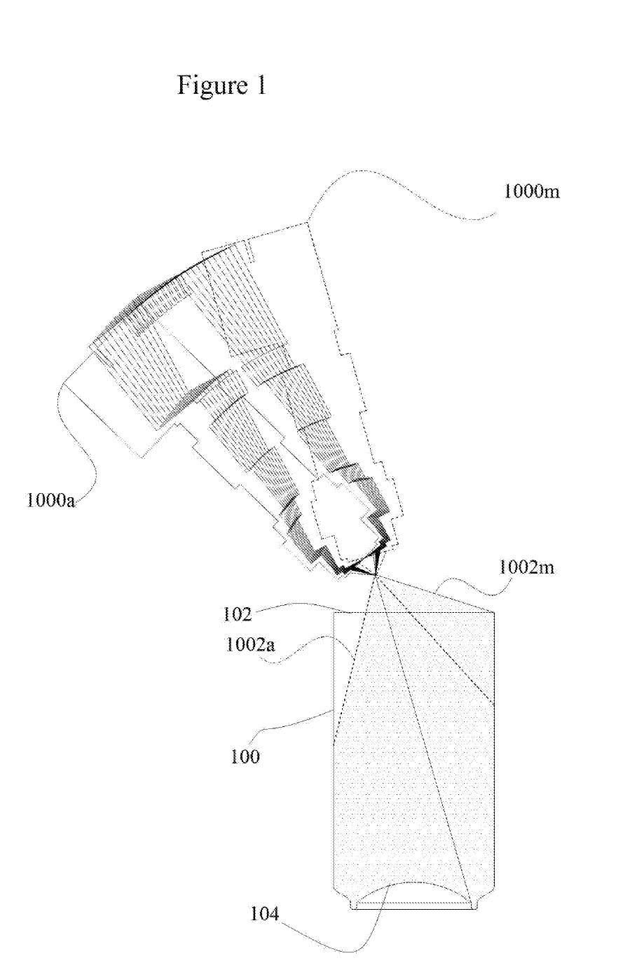

FIG. 1 is a cross-sectional simplified view of a nodding spray gun according to the first embodiment of the invention, showing some exemplary positions which it can attain while rotating and the effect on spraying within the cylindrical body, in this case a can. Cylindrical body 100 has open end 102 and closed end 104. Closed end 104 is domed in the illustration.

In the first embodiment of the invention, the spray gun has a multiplicity of possible positions it may reach along an arcuate path of rotation about the nozzle end of the gun. First exemplary position 1000a may for example be one end of a limit of rotational travel, but in other embodiments may not be the extreme end of travel. It may be a start position but is not so limited. From this position a number of example positions are shown, however, it will be understood that the dozen or so positions shown are merely examples and the invention is not so limited. By means of structures disclosed below, the invention may assume an almost infinite number of angular positions. Thirteenth exemplary position 1000m may be an ending position, or an intermediate position, or may represent the opposite limit of angular travel of the spray gun barrel, but again it is not limited to any of these.

As noted previously, these positions are measured in reference to the cylindrical container 100, which may be seen to have a longitudinal axis of symmetry.

Thirteenth exemplary position 1000m is at a substantially different angle, perhaps 30 degrees, different from the first position 1000a, in reference to the can 100.

First position spray area 1002a is thus naturally different from thirteenth position spray area 1002m. (First position spray area 1002a is delimited by solid lines at the edges, while spray area 1002m is marked off by dashed lines at the edges.) It will immediately be seen that the spray areas are not identical.

Thus by providing angular motion of the spray gun, not in between sprays but rather during spraying, a greater surface area may be covered by the spray gun.

However, thought will show that this is not the only advantage. Among other advantages, a spray system might be selected in which the spray gun is used to spray more coating onto one area of the side wall than onto another area of the container, which will be discussed further below.

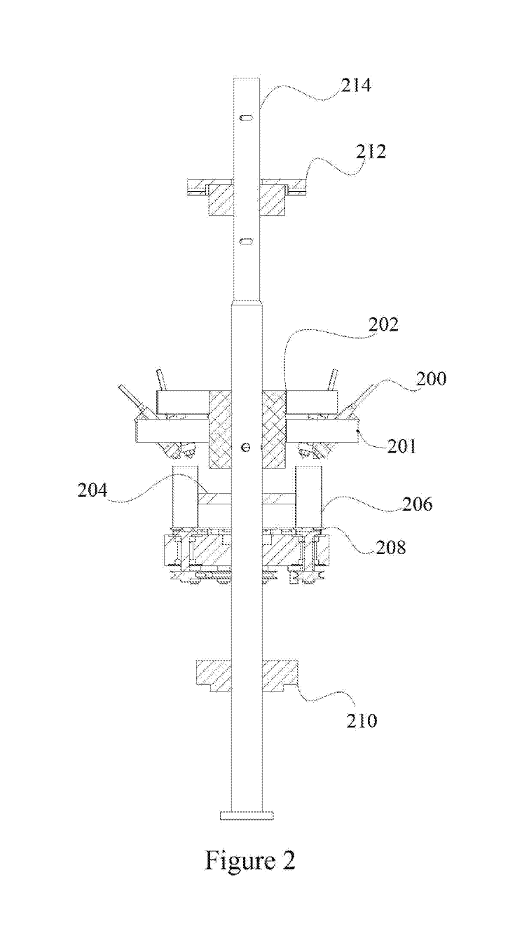

FIG. 2 is a cross-sectional view of a spray machine showing the context of use of the second embodiment, with spray guns on a rotating turret above a rotating star wheel in a vertical spray orientation.

Spray gun 200 may be seen attached to gun mount 201 which is itself merely part of a larger gun mount fixture (or spray gun turret) 202. This turret 202 may revolve about support/drive shaft 214, revolving either with the shaft or independently of it as engineering needs dictate.

Vacuum chuck spinner 208 holding can 206 may also be seen underneath the turret 202/gun 200. The star wheel 204 may also revolve about the shaft/support 214. In particular, the star wheel 204, vacuum chuck 208, and the turret 202 may revolve together about the support drive shaft. Note that they may also be entirely separated structures, or the drive shaft 214 may be omitted, but they may nonetheless revolve together.

The benefit of co-revolution is that the gun may remain over the can the entire time that the can is in the star wheel, and may even spray while the wheel is in motion. This means that the individual spray gun can spend more time spraying and less time waiting for the transport of a can by the star wheel until the can is under the gun.

In prior art spray systems, motion of the gun would not be practical as the additional time required for a nodding gun would require the can to remain motionless under the spray gun for a longer period of time. This would dramatically slow production. By moving the gun with the can, more time is made available for spraying and this in turn allows more options for spraying, such as nodding. Nodding the gun then allows additional spraying techniques not known in the art, as will be discussed below in regard to spraying of differential thickness coating.

Can spinner/vacuum chuck 208 may hold a can in the pocket of the star wheel as the star wheel turns, and in addition may spin the can.

Bottom support 210 and top support 212 are pictured, allowing equipment support.

Support/drive shaft 214 as noted previously may either revolve the turret 202 and the star wheel 204 or may simply be support.

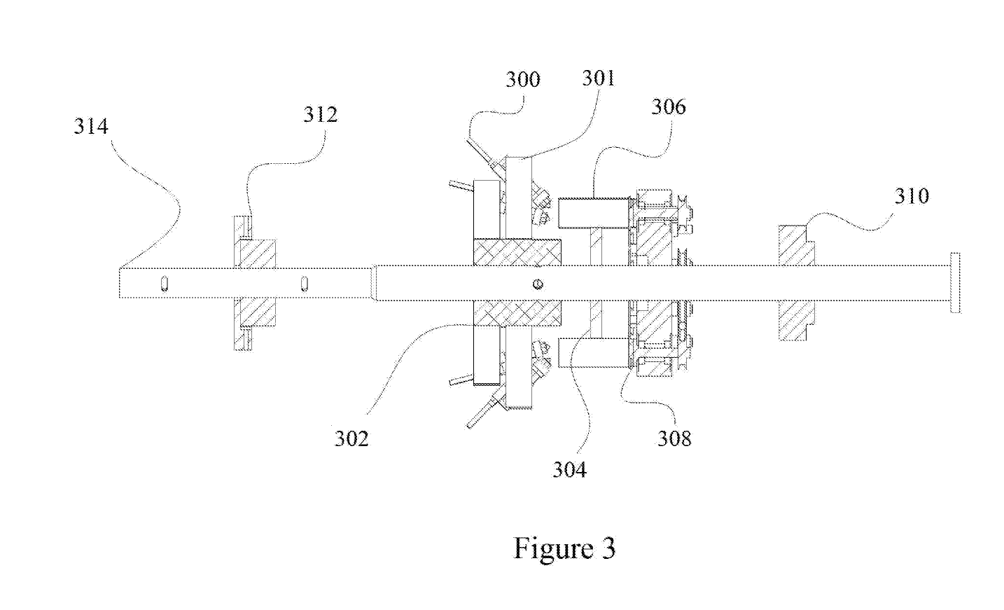

FIG. 3 is a cross-sectional view of a spray machine showing the context of use of the third embodiment, with spray guns on a rotating turret beside a rotating star wheel in the traditional horizontal orientation. This method of production may be slower in embodiments, so the previous embodiment of FIG. 2 is presently preferred and the best mode now contemplated.

Spray gun 300, gun mount 301, gun mount fixture (the turret) 302 and the star wheel 304 operate in a manner largely similar to that discussed previously to coat the interior surfaces of can 306.

Can spinner/vacuum chuck 308, right support 310, left support 312 and support/drive shaft 314 may also operate much as previously discussed.

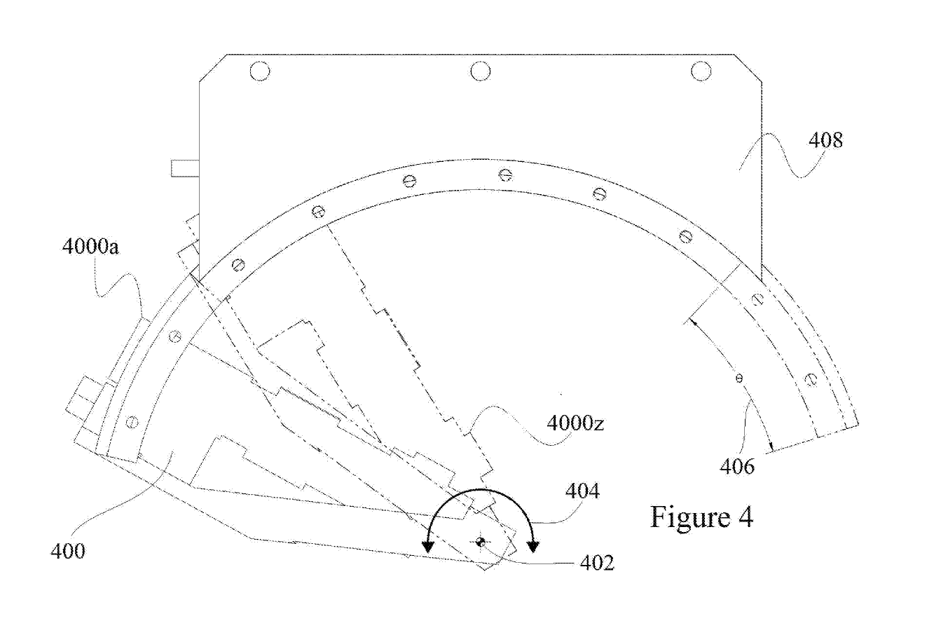

FIG. 4 is a side view of a fourth embodiment of the invention showing a positioning goniometer spray gun mount as well as the spray gun in two exemplary positions, the angle of rotation, center of rotation and so on.

Spray gun 400 has a center of rotation 402 located directly at the nozzle end of the spray guns barrel body. Thus rotation 404 may occur not about the back end of the spray gun, nor about an intermediate point, but may occur about the nozzle.

Angular freedom of rotation 406 (theta) shows the degree of freedom the gun and gun mount plate may have, in this case, about 30 degrees. The motion available may be much more than 30, even in embodiments up to 180 degrees, or may be less, just a few degrees.

Positioning goniometer 408 is a device used to provide exactly precise degrees of angular motion. This not only allows an extremely large number of positions (for example at an angular accuracy of only 1/10 of a degree and an angular play (theta-sub-1 minus theta-sub-2) of 30 degrees, 300 different positions may be attained. With analog control this number can be infinite to available ability to measure, within the scope of the invention.

Start position example 4000a (theta-sub-1) and end position example 4000z (theta-sub-2) may show the maximums for this particular theta.

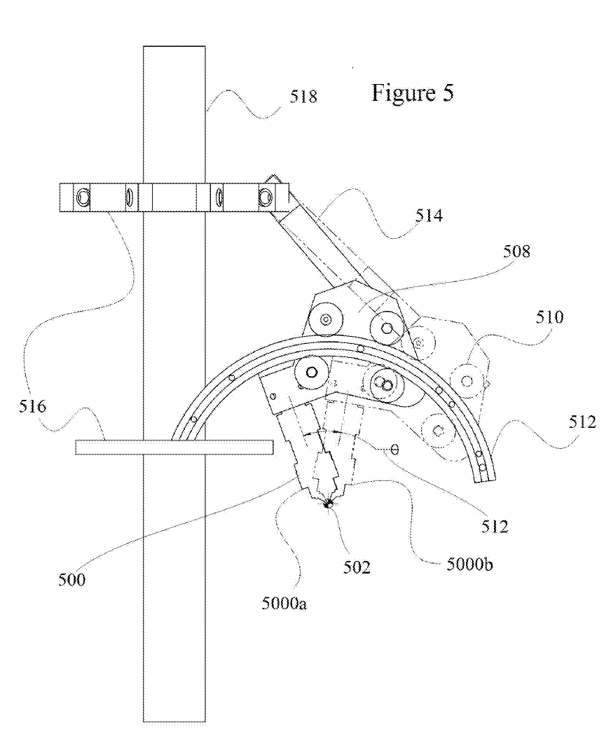

FIG. 5 is a side view of a fifth embodiment of the invention showing a linear actuator and curved linear rail spray gun mount as well as the spray gun and its mount in two exemplary positions, the angle of rotation, center of rotation and so on, plus a short section of the overall machine.

Spray gun 500 has a center of rotation 502 at the nozzle, and rotation angle 506 (theta). Gun mounting plate 508 (not to be confused with mounting plates 516) rides a curved/arcuate rail or track or cam 512 by means of guides/followers 510. The guides 510 and the linear rail 512 cooperate mechanically to prevent motion from departing the track in any dimension: the only gun motion permitted is rotational motion by moving the mounting plate 508 along the track.

Linear actuator 514 may be a linear electric motor as well, and is attached to the gun assembly mounting plates 516 on the main shaft 518. This end is thus “fixed” relative to the shaft 518, though it obviously revolves as discussed previously in regard to turret 202. The other end of the linear actuator 514 may lengthen or extend so as to move the gun mounting plate 508 back and forth along the track, resulting in the gun's rotation.

First angular position 5000a and second angular position 5000b are seen together (solid lines/dashed lines−shadow) for comparison purposes. It is immediately obvious that the nozzle is not moving as the gun rotates.

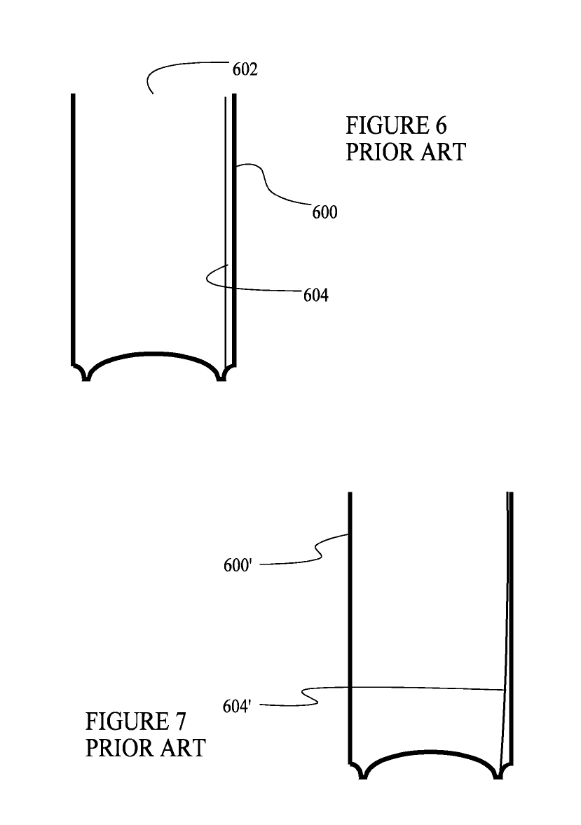

FIG. 6 is a PRIOR ART vastly simplified cross-sectional view of a cylindrical body immediately after being sprayed with a prior art spray gun. FIG. 7 is a PRIOR ART vastly simplified cross-sectional view of a cylindrical body after being sprayed with a prior art spray gun and further after the coating has had time to sag downward on the interior surface of the cylindrical body. Can 600 has an open end 602. In practice, it may be desirable to have the coating within the can be applied very evenly. After spraying the coating (in a partially fluid phase) 604 is evenly applied and thus of even thickness everywhere. However, the coating, although atomized, has not yet hardened into a solid phase. Thus, shortly thereafter the same PRIOR ART can (designated with a “prime” or apostrophe) can 600′ has suffered having the internal coating slump or sag, 604′, during this PRIOR ART process. The coating has thus become uneven despite being applied evenly. This means in practice that can makers must apply even more coating than they want in order, simply in order to provide a safety factor.

Even more commonly, the can must be “necked” or have its physical geometry (shape and size) changed at the open end, for example, in preparation for having a top put on or for other reasons such as aesthetics, or to make a more convenient shape for pouring or opening or the like. The necking operation may damage the coating, so it would be desirable to provide extra thickness to the coating at the areas near the open end of the can.

Thus, for various reasons now known or later discovered, it may be desirable to have the ability to apply a coating having different thicknesses at different locations within the can. This differential coating thickness is discussed previously in the Glossary.

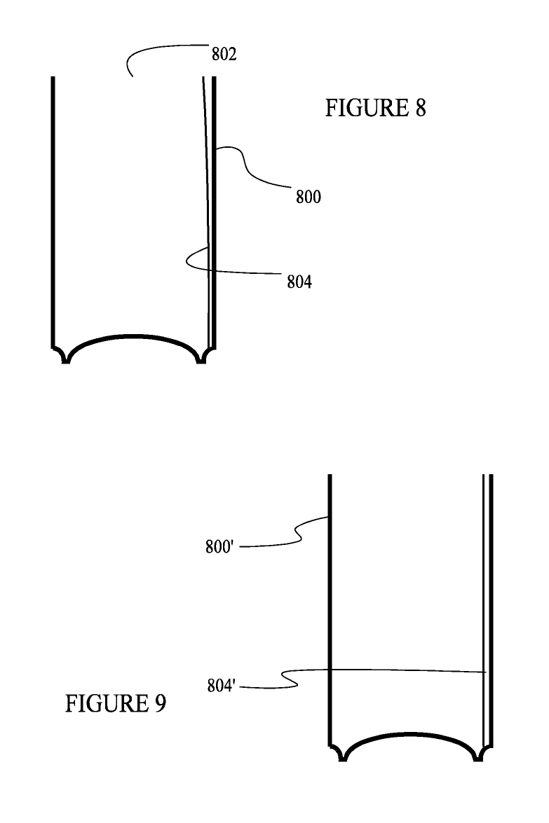

FIG. 8 is a vastly simplified cross-sectional view of one potential coating differential thickness coating (so-called “pattern”) of a cylindrical body immediately after being sprayed with a nodding spray gun according to the invention, and FIG. 9 is a vastly simplified cross-sectional view of one a potential differential thickness coating pattern of a cylindrical body after being sprayed with a nodding spray gun according to the invention and additionally, after the coating has had time to sag downward on the interior surface of the cylindrical body.

Can 800 has received, in a first area near the open end 802, a coating which is seen to be a differential coating thickness application 804. In particular, the thickness of the coating is greater near the top than near the bottom. This was achieved by “nodding” or rotating the gun. For example, less time might be spent spraying the bottom/closed end/dome of the can than the top of the can.

This may be desirable for numerous reasons, such as due to the product being packaged, or to save material, or operational improvements, or because the spinning dome of the can may sling the coating right off.

Can 800′ (the same can, slightly later) has allowed gravity to draw the differential thickness coating down into the desired alignment. In this case, the desired shape is generally a regular coat, 804′. However, as mentioned previously, due to “necking”, it may be desirable for the coating (after being gravity drawn) may still be thicker at the top than the bottom.

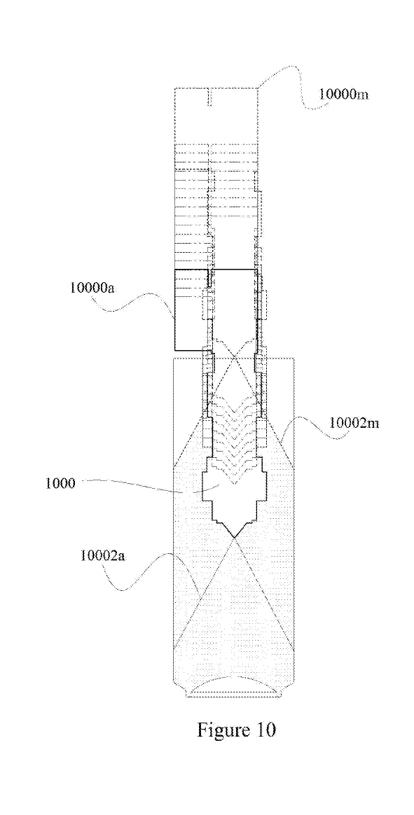

FIG. 10 is a partially transparent side view of a spray gun moving in a lancing motion, showing various exemplary positions. Spray gun 1100 may be in start position (an example) 10000a and later be in end position (exemplary) 10000m and thus deliver a differential thickness coating spray between initial spray area 10002a and lancing spray area 10002m. In this embodiment, the linear actuator will be used to provide not a rotational motion but instead a motion in translation, that is, motion directly along the axis of the spray gun barrel. The lancing motion will entail the gun mounted to a linear actuator which is oriented vertically and which will be actuated to move the nozzle down into the can and then be retracted, partially or wholly, while for some portions of the cycle spraying the dome and sidewall. It is specifically used for cans that have a larger height to diameter aspect ratio, where spraying the large distance to the dome is problematic, however, the invention is not so limited. The linear actuator provides numerous advantages for this motion.

Note that these methods are not mutually exclusive and in embodiments may be used together.

TABLE ONE

| STEP # | ACTION |
|---|---|
| A. | providing a sprayer able to spray a greater amount of a coating |
| | at a first location in a container compared to a second location, |
| | the coating being at least partially liquid phase |
| B. | hold container and sprayer at a mutual angle theta and a mutual |
| | location |
| C. | moving the sprayer with the container so that spraying can occur |
| | while the container is in motion |
| D. | rotating/nodding the sprayer about the nozzle end while spraying |
| E. | thus spraying the greater amount of coating at the first location |
| | compared to the second location |
| F. | allowing gravity to draw coating material from the first location |
| | to the second location before the coating material begins to |
| | solidify, the first location being near to the open end but the |
| | second location near to the closed end |

Note that some of these steps may be omitted, the steps may be combined with steps of providing the structures detailed elsewhere in this application and so on. In particular, the steps above may optionally include lancing the sprayer system so that the nozzle moves in relation to the container. The step of spraying a differential coating thickness may be omitted, and so on.

Throughout this application, various publications, patents, and/or patent applications are referenced in order to more fully describe the state of the art to which this invention pertains. The disclosures of these publications, patents, and/or patent applications are herein incorporated by reference in their entireties, and for the subject matter for which they are specifically referenced in the same or a prior sentence, to the same extent as if each independent publication, patent, and/or patent application was specifically and individually indicated to be incorporated by reference.

Methods and components are described herein. However, methods and components similar or equivalent to those described herein can be also used to obtain variations of the present invention. The materials, articles, components, methods, and examples are illustrative only and not intended to be limiting.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art.

Having illustrated and described the principles of the invention in exemplary embodiments, it should be apparent to those skilled in the art that the described examples are illustrative embodiments and can be modified in arrangement and detail without departing from such principles. Techniques from any of the examples can be incorporated into one or more of any of the other examples. It is intended that the specification and examples be considered as exemplary only, with a true scope and spirit of the invention being indicated by the following claims.

We claim:

1. A spray system for coating the inner surface of a cylindrical item of manufacture, the spray system comprising:
a generally cylindrical spray gun barrel having a first back end to receive a coating such as lacquer and a second nozzle end to spray the coating, the spray gun barrel having a longitudinal axis;
the spray gun barrel and such cylindrical item of manufacture being held respectively by a gun mount and a vacuum chuck, the spray gun barrel and such cylindrical item of manufacture being held at a mutual angle theta, the spray gun barrel nozzle end and such cylindrical item of manufacture also being held in a first mutual position;
the gun mount being operative to rotate the spray gun barrel while the spray gun barrel is spraying such inner surface of such cylindrical item of manufacture, the center of the rotation C being the nozzle, the mutual angle theta changing from a first angle theta-sub-1 to a second angle theta-sub-2 due to the rotation;
whereby the mutual angle theta changes but the first mutual position of the spray gun nozzle and such cylindrical item of manufacture does not change.

2. The sprayer of claim 1, wherein the gun mount further comprises:
a curved rail, the rail having a radius of curvature equal to the length L of the spray gun barrel as measured from the rail to the nozzle, the radius of curvature having a focus at the center of rotation C.

3. The sprayer of claim 2, wherein the gun mount further comprises:
a gun mounting plate, the gun barrel attached to the gun mounting plate, the gun mounting plate having guides movably affixed to the curved rail such that the guides, gun mounting plate and gun barrel may ride along the curved rail but may not depart from the curved rail.

4. The sprayer of claim 3, wherein the guides are rollers.

5. The sprayer of claim 3, wherein the guides are cam followers.

6. The sprayer of claim 3, further comprising:
a linear actuator having a first end attached to the gun mounting plate and having a second end attached to a spray gun turret;
the spray gun turret revolving with the star wheel and holding the spray gun in the first mutual position as the star wheel and spray gun turret revolve;
the linear actuator operative to move the spray gun barrel while it is spraying, thereby causing the rotation of the spray gun.

7. The sprayer of claim 7, wherein the linear actuator is a linear electric motor.

8. The sprayer of claim 3, the gun mounting plate further comprising:
a positioning goniometer, the positioning goniometer operative to move the spray gun barrel along the rail while it is spraying, thereby causing the rotation.

9. The sprayer of claim 6, wherein the linear actuator allows the spray gun to rotate to any angle within the range theta-sub-1 to theta-sub-2.

10. The sprayer of claim 6, wherein the range theta-sub-1 to theta-sub-2 is at least 30 degrees.

11. A sprayer for coating the inner surface of a cylindrical item of manufacture, the sprayer comprising:
a generally cylindrical spray gun barrel having a first back end to receive a coating such as lacquer and a second nozzle end to spray the coating, the spray gun barrel having a longitudinal axis;
the spray gun barrel and such cylindrical item of manufacture being held respectively by a gun mount and a star wheel, the spray gun barrel and such cylindrical item of manufacture being held at a mutual angle theta, the spray gun barrel nozzle end and such cylindrical item of manufacture also being held in a first mutual position;
a linear actuator attached to the gun mount, the linear actuator being operative to move the spray gun barrel in translation along the longitudinal axis toward such cylindrical item of manufacture while the spray gun barrel is spraying such inner surface of such cylindrical item of manufacture.

12. A method for coating the inner surface of a cylindrical item of manufacture, the method comprising:
providing a sprayer able to spray a greater amount of a coating at a first location compared to a second location, the coating being at least partially liquid phase;
spraying the greater amount of coating at the first location compared to the second location.

13. The method of claim 12, further comprising:
allowing gravity to draw coating material from the first location to the second location before the coating material begins to solidify.

14. The method of claim 13, wherein such cylindrical item of manufacture has an open end and a closed end; and further comprising the step of:
orienting vertically the cylindrical item of manufacture while it is being sprayed, with the open end upward;
and further wherein:
the first location is near to such open end and the second location is near to such closed end.

15. The method of claim 14, wherein the step of providing the sprayer further comprises providing a sprayer comprising:
a generally cylindrical spray gun barrel having a first back end to receive the coating and a second nozzle end to spray the coating, the spray gun barrel having a longitudinal axis;
the spray gun barrel and such cylindrical item of manufacture being held respectively by a gun mount and a star wheel, the spray gun barrel and such cylindrical item of manufacture being held at a mutual angle theta, the spray gun barrel nozzle end and such cylindrical item of manufacture also being held in a first mutual position, the spray gun turret revolving with the star wheel and holding the spray gun in the first mutual position as the star wheel and spray gun turret revolve;
the gun mount being operative to rotate the spray gun barrel while the spray gun barrel is spraying such inner surface of such cylindrical item of manufacture, the center of the rotation C being the nozzle, the mutual angle theta changing from a first angle theta-sub-1 to a second angle theta-sub-2 due to the rotation;
whereby the mutual angle theta changes but the first mutual position of the spray gun nozzle and such cylindrical item of manufacture does not change;
the gun mount having a curved rail, the rail having a radius of curvature equal to the length L of the spray gun barrel as measured from the rail to the nozzle, the radius of curvature having a focus at the center of rotation C, the gun mount further having a gun mounting plate, the gun barrel attached to the gun mounting plate, the gun mounting plate having guides movably affixed to the curved rail such that the guides, gun mounting plate and gun barrel may ride along the curved rail but may not depart from the curved rail. a linear actuator having a first end attached to the gun mounting plate and having a second end attached to a spray gun turret;
the linear actuator operative to move the spray gun barrel while it is spraying, thereby causing the rotation of the spray gun.
